(19) United States
(12) Patent Application Publication
(10) Pub. No.: US 2016/0325944 A1
(43) Pub. Date: Nov. 10, 2016

(54) SYSTEM AND METHOD FOR LOADING/UNLOADING ARTICLE ARRAY HEAD

(71) Applicant: DYCO, INC., Bloomsburg, PA (US)

(72) Inventors: Peter D. YOHE, Bloomsburg, PA (US); Ronald H. CORDINGLY, Berwick, PA (US); Jeffrey W. Hess, Bloomsburg, PA (US)

(21) Appl. No.: 14/705,072

(22) Filed: May 6, 2015

(51) Int. Cl. B65G 47/90; B65G 57/03

(52) U.S. Cl. CPC B65G 47/90; B65G 57/03

(57) ABSTRACT

A system for loading/unloading an article array head including a frame and a carriage selectively movably supported in a horizontal direction by the frame, the carriage selectively movably supporting an article array head in a vertical direction, movement of the article array head is constrained to interior of the frame. The article array head is suspended from the carriage by flexible members. The carriage is incapable of simultaneously moving the article array head in the horizontal direction and the vertical direction.

### FIELD OF THE INVENTION

The present invention is directed to a system and method for equipment associated with loading and unloading palletizing article arrays or portions thereof.

### BACKGROUND OF THE INVENTION

When large numbers of stackable articles must be transported in large quantities to another location, especially when the article is small, the article may be packaged in a container to protect the article during shipping of the container. Alternately, to reduce the amount of handling required and/or to reduce the amount of shipping material consumed, the articles may be arranged in a tight grouping, or array of articles. Each array of articles can form a layer of articles that can be stacked on a pallet having a footprint which can be accommodated by freight hauling compartments, e.g., for truck, rail, sea or air vessels.

Palletizing articles is becoming increasingly automated in manufacturing facilities, wherein articles are moved via a conveyor, which articles are manipulated by dedicated machinery onto pallets.

It would be beneficial to develop and use a system and method for loading/unloading article array heads.

### SUMMARY OF THE INVENTION

The disclosure is directed to a system for loading/unloading an article array head including a frame and a carriage selectively movably supported in a horizontal direction by the frame. The carriage is selectively movably supporting an article array head in a vertical direction, movement of the article array head is constrained to interior of the frame. The article array head is suspended from the carriage by flexible members. The carriage is incapable of simultaneously moving the article array head in the horizontal direction and the vertical direction.

The disclosure is also directed to a method for loading/unloading an article array head including providing a frame configured to receive an article array in a first station of the frame and a component to be positioned beneath or over the article array and a second station of the frame. The method further includes moving the component from the second station to the first station over the article array or moving the article array from the first station to the second station over the component, using a combination of vertical movement and horizontal movement. The vertical movement and the horizontal movement do not occur simultaneously, and movement of both the component and the article array is constrained to interior of the frame.

The disclosure is yet further directed to a system for loading/unloading multiple article array heads including a frame and a first carriage selectively movably supported in a horizontal direction by the frame. The first carriage is selectively movably supporting a first article array head in a vertical direction, movement of the first article array head is constrained to interior of the frame. The first article array head is suspended from the first carriage by first flexible members. The first carriage is incapable of simultaneously moving the first article array head in the horizontal direction and the vertical direction. A second carriage is selectively movably supported in a horizontal direction by the frame, the second carriage is selectively movably supporting a second article array head in a vertical direction. Movement of the second article array head is constrained to interior of the frame. The second article array head is suspended from the second carriage by second flexible members. The second carriage is incapable of simultaneously moving the second article array head in the horizontal direction and the vertical direction.

In the present invention, by suspending the article array head from a carriage by flexible members, the number of components is reduced, thereby reducing the cost of the system. For example, in one embodiment, actuation of a single motor drivably retracts/deploys the flexible members. By rendering incapable simultaneous vertical and horizontal movement of the article array head during operation, and utilizing a guide system, precise positioning control of the article array head is maintained, despite the use of flexible members.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is an upper perspective view of an exemplary article array head loading/unloading system.

FIG. 2 is an upper perspective view of an exemplary article array head loading/unloading system.

FIG. 3 is an upper perspective view of an exemplary article array head loading/unloading system.

FIG. 4 is a front view of the loading/unloading system of FIG. 3 reduced to the loading/unloading system of FIG. 2, for purposes of describing the operation of the loading/unloading system of FIG. 2.

FIGS. 5-17 are sequential operational movements of the loading/unloading system of FIG. 2.

FIG. 18 is an enlarged upper perspective view of an exemplary carriage and article array head in a retracted vertical position.

FIG. 19 is a cross section of the carriage taken along 19-19 of FIG. 18.

FIG. 20 is an enlarged upper perspective view of an exemplary carriage and article array head in an extended vertical position.

FIG. 21A is a front view of an exemplary carriage and article array head in a partially extended vertical position.

FIG. 21B is a front view of an exemplary carriage and article array head in a retracted vertical position.

FIG. 22A is a side view of an exemplary arrangement for providing horizontal movement of an exemplary carriage and article array head.

FIG. 22B is an upper perspective view of an exemplary arrangement for providing horizontal movement of an exemplary carriage and article array head.

FIG. 23 is a front view of a portion of an exemplary guide system for an exemplary carriage and article array head.

FIG. 24 is an enlarged front view of a portion of an exemplary guide system for an exemplary carriage and article array head.

FIG. 25A is an upper perspective view of an exemplary arrangement for providing horizontal movement of a plurality of exemplary carriages and article array heads.

FIG. 25B is a plan view of an exemplary arrangement for providing horizontal movement of a plurality of exemplary carriages and article array heads.

### DETAILED DESCRIPTION OF THE INVENTION

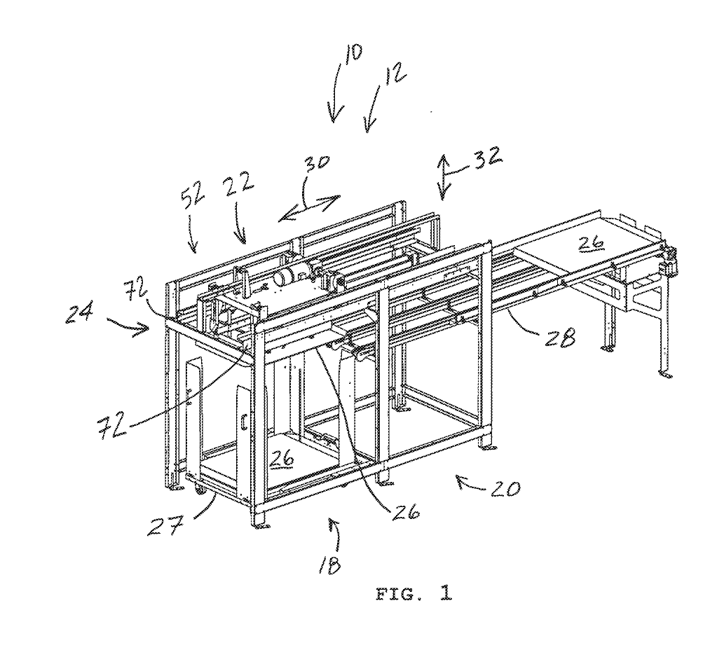

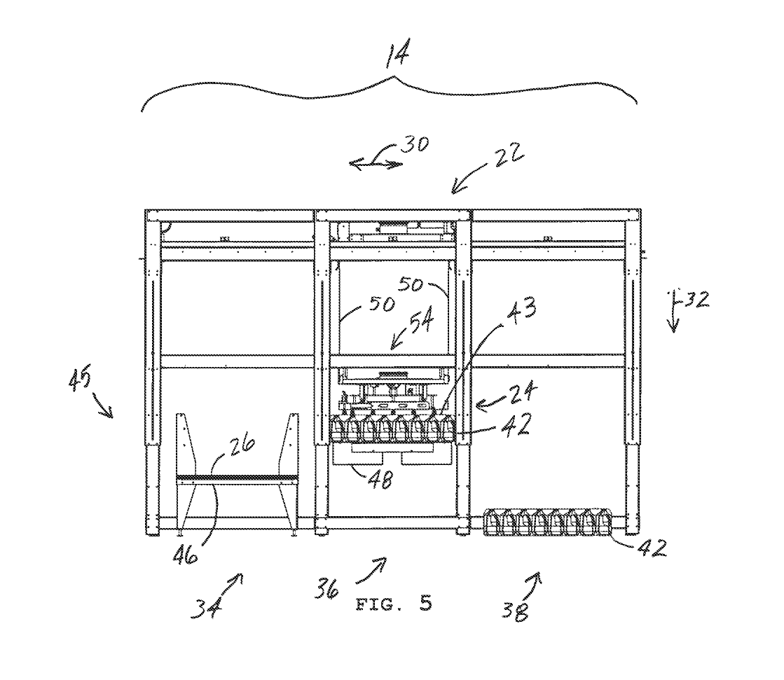

Referring to FIG. 1, a system 10 for loading/unloading an article array head 24 is shown. System 10 includes a two-position frame 12 having a position or station 18 and a position or station 20. Frame 12 includes a guide rail 72 for selectively movably supporting a carriage 22 in a horizontal direction 30, with carriage 22 selectively movably supporting an article array head 24 in a vertical direction 32 using flexible members 50 (FIG. 5), as will be further discussed in detail below. As further shown in FIG. 1, array head 24 is utilized to move component 26, such as a top cap from a guide device 27 positioned in station 18 to station 20, placing component 26 onto a conveyor 28 that is moved in horizontal direction 30 away from station 20 for further processing.

For purposes herein, “article array head”, “array head”, “head” or the like refers to equipment associated with loading/unloading palletizing article arrays or portions thereof. For example, an article array head may include a palletizer, a gripping device for gripping and transporting at least a portion of an article array, including a bag or oriented articles, such as produced by an array head, a slip sheet mover, a top cap mover or a combination thereof.

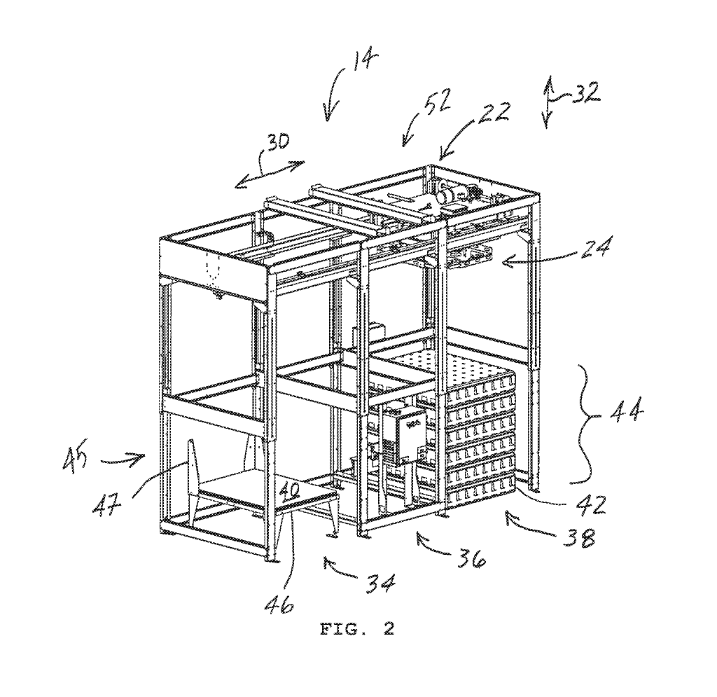

FIG. 2 shows a three-position frame 14 similar to two-position frame 12, with frame 14 having a position or station 34, a position or station 36 and a position or station 38. Station 34 includes a guide system 45 including a guide 46 for supporting and positioning components 40, such as slip sheets that may be placed between adjacent article arrays 42. Guide 46 may have wheels for ease of removal from station 34, although in other embodiments, guide 46 may have legs without wheels, may be directly connected to the frame, form a portion of the frame or extend inside or interior of a station from exterior of the frame, or some other structural arrangement. Article arrays 42 are provided to station 36 such as by a conveyor 48 (FIG. 5). Conveyor 22 and article array head 24 selectively move and position components 40 from station 34 and article arrays 42 from station 36 to station 38, forming palletized article arrays. As further shown in FIG. 2, a partially palletized array 44 is shown.

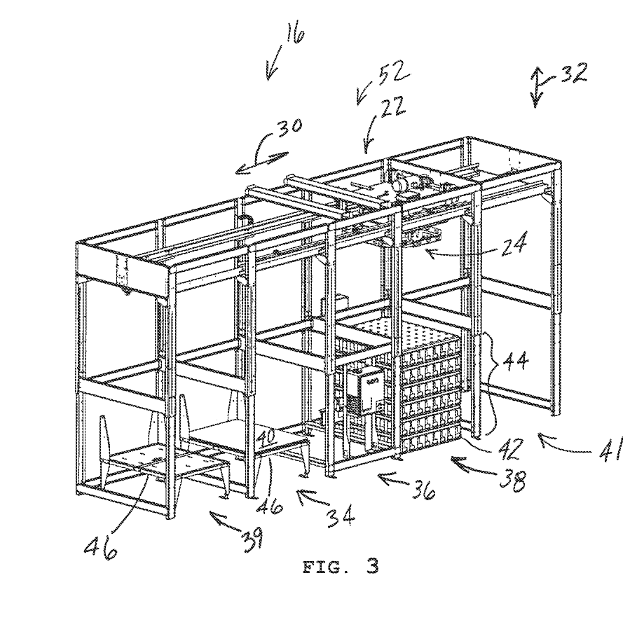

FIG. 3 shows a five-position frame 16 similar to three-position frame 14, except with the addition of station 39 and station 41. In one embodiment, station 39 may include a guide device 46 for supporting and positioning components 40, such as end caps that are placed on top of palletized article arrays. In one embodiment, station 41 may be used to build a palletized article array, permitting continuous operation of the system while a palletized article array in station 38 is being removed, or other desired purpose.

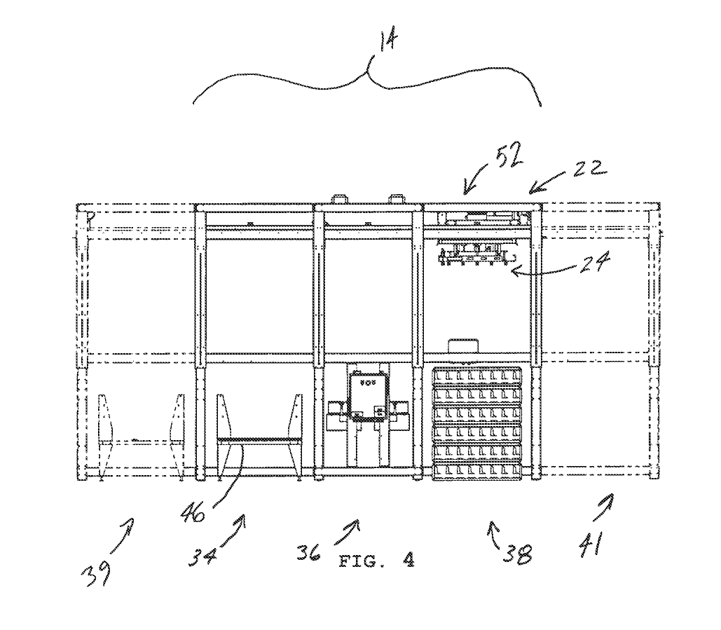

FIG. 4 shows stations 34, 36, 38 of three-position frame 14 (with stations 39, 41 of five-position frame 16 (FIG. 5) shown in phantom lines, but not further discussed), for simplifying an understanding of the operation of the loading/unloading system, as will be further discussed in FIGS. 5-17.

FIG. 5 shows station 36 which includes a conveyor 48 for conveying article array 42 to station 36. Conveyor 22 deploys flexible material 50 from which article array head 24 is suspended, lowering article array head 24 in a vertical direction 32 until article array head 24 is guided to or in close proximity to an extended vertical position 54. In extended vertical position 54 or in close proximity thereto, article array head 24 engages article array 42. Operation of conveyor 22 will be discussed in further detail below.

It is to be understood that the article array head may utilize a vacuum to engage the article array or components, gripping devices, a combination thereof, or other suitable engagement device construction. In one embodiment, an article array vacuum head may be utilized to engage one or more of the article array or components. In another embodiment, a single article array head may be utilized to engage all combinations of article arrays and components. For example, as shown in FIGS. 5-17, the exemplary embodiment article array head utilizes a vacuum, and may be used to engage both components 26 and article arrays 42, with article arrays 42 being enclosed within a bag 43, such as produced by a bagger or bagging system. In other embodiments, more than one article array head may be required, and more than one carriage may be utilized, as will be further discussed in detail below.

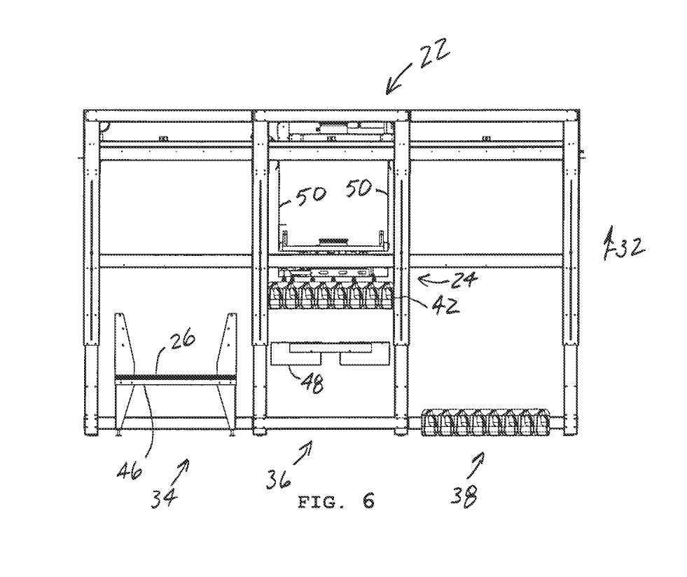

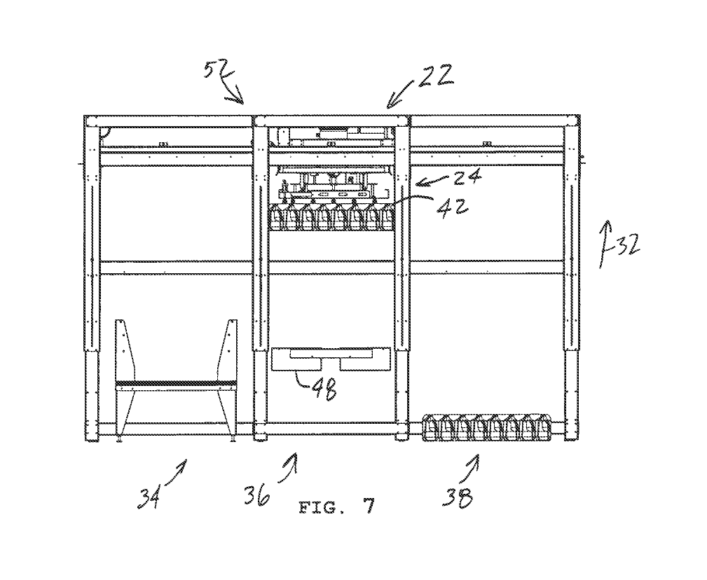

Once article array head 24 engages article array 42, as shown in FIG. 6, carriage 22 retracts flexible material 50, resulting in article array head 24 and article array 42 being raised in vertical direction 32 away from conveyor 48. Article array 42 and article array head 24 are further raised in vertical direction 32 until reaching a retracted vertical position 52 or are in close proximity thereto as shown in FIG. 7.

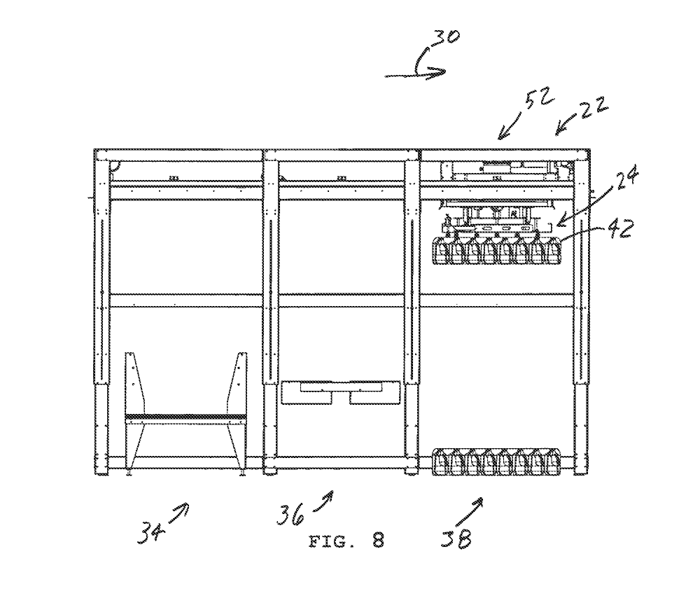

Once article array 42 and article array head 24 have reached or are in close proximity to retracted vertical position 52, as shown in FIG. 8, carriage 22 is moved from station 36 to station 38 in horizontal direction 30.

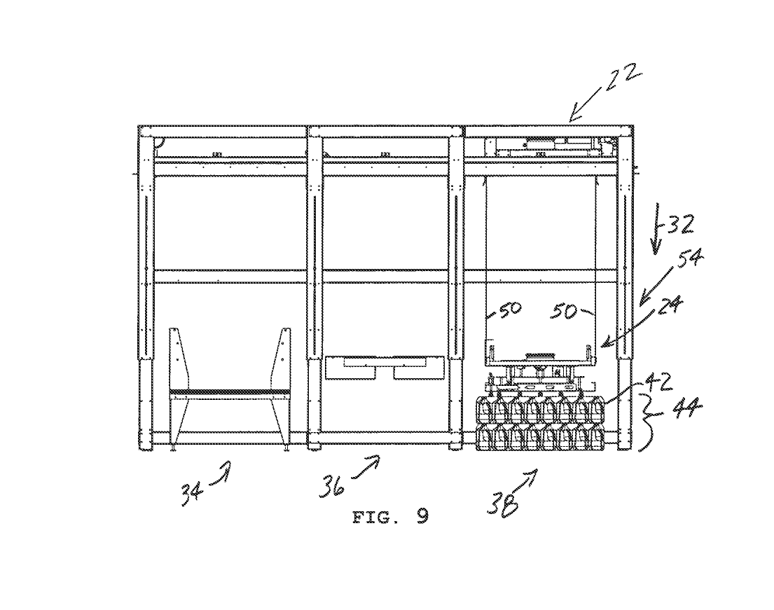

Once carriage 22 reaches station 38, as shown in FIG. 9, flexible material 50 is deployed from carriage 22, lowering article array head 24 and article array 42 in vertical direction 32. Article array head 24 and article array 42 are further lowered in vertical direction 32 until reaching or are in close proximity to an extended vertical position 54, such that the article array 42 engaged with article array head 24 engages the top of the previously positioned article array 42, forming a partially palletized array 44. For purposes herein, the term “engage”, “engages”, “in engagement with” or the like and “in contact with”, “contacts” and the like may be used interchangeably.

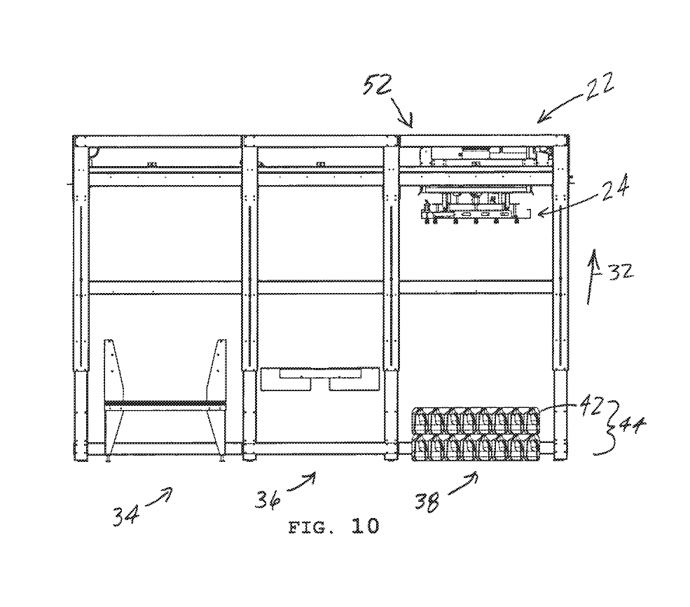

Once article array head 24 is disengaged from article array 42, flexible members 50 are retracted such that article array head 24 moves in vertical direction 32 until reaching or is in close proximity to retracted vertical position 52 of station 38, as shown in FIG. 10.

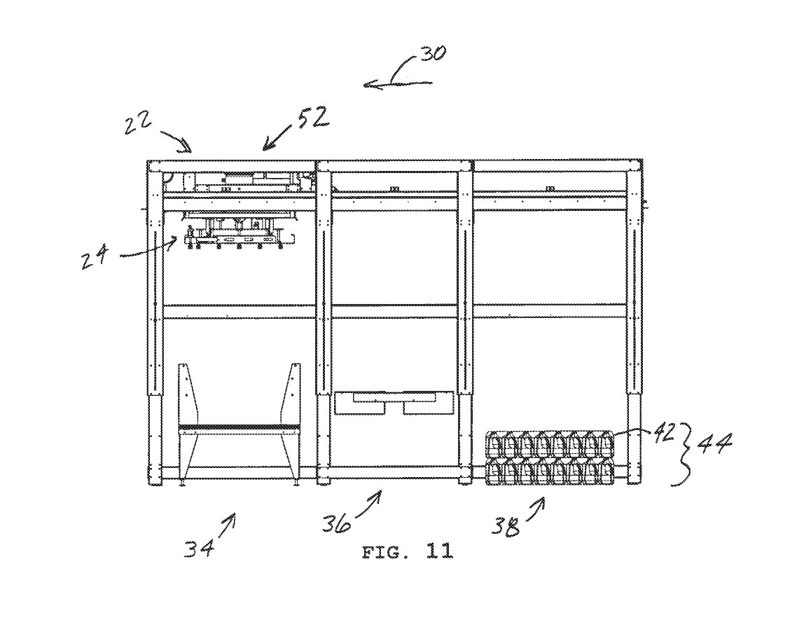

Once article array head 24 reaches or is in close proximity to retracted vertical position 52, carriage 22 is moved in horizontal direction 30 from station 38 to station 34, as shown in FIG. 11.

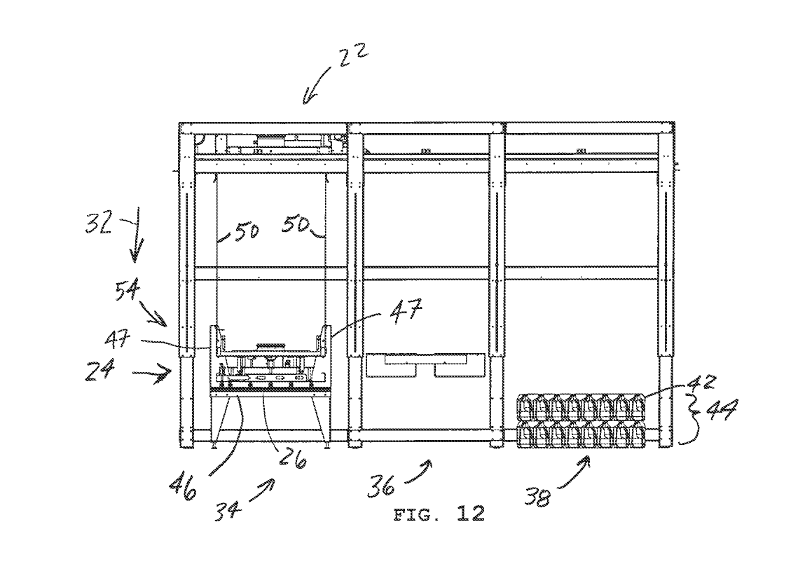

Once carriage 22 reaches station 34, flexible members 50 are deployed from carriage 22, lowering article array head 24 in vertical direction 32. As shown in FIG. 12, article array head 24 is further lowered in vertical direction 32 until reaching or is in close proximity to an extended vertical position 54, such that article array head 24 is brought into close proximity with or into physical contact with component 26, and is engaged with component 26. In one embodiment, guide members 47 of guide device 46 may assist with guiding article array head 24 as article array head 24 is lowered toward component 26.

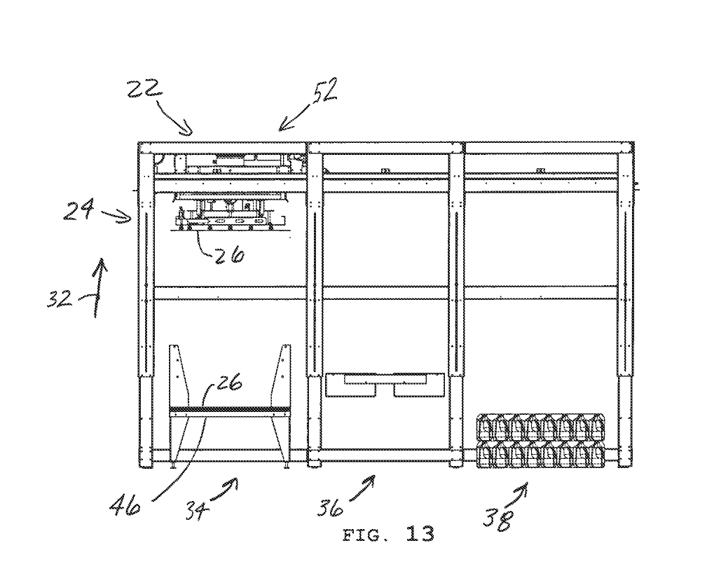

Once article array head 24 engages component 26, article array head 24 and component 26 are raised in vertical direction 32 until reaching or are in close proximity to a retracted vertical position 52 in station 34, as shown in FIG. 13.

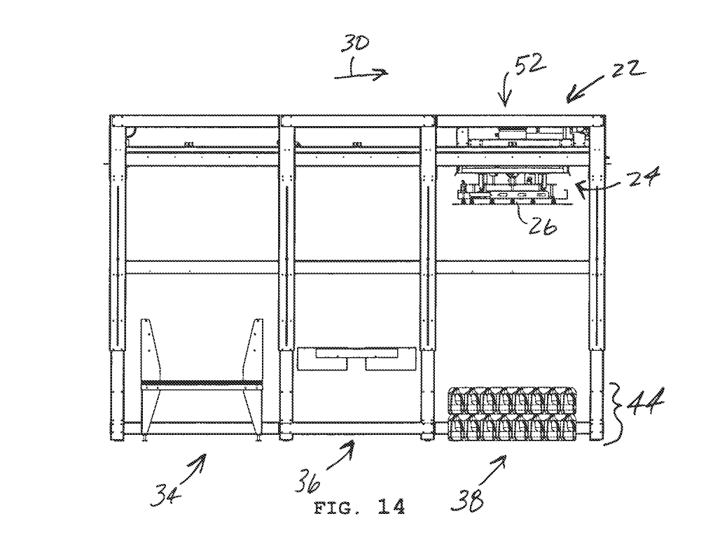

Once article array head 24 and component 26 reach or are in close proximity to retracted vertical position 52, carriage 22 is moved in horizontal direction 30 from station 34 to station 38, as shown in FIG. 14.

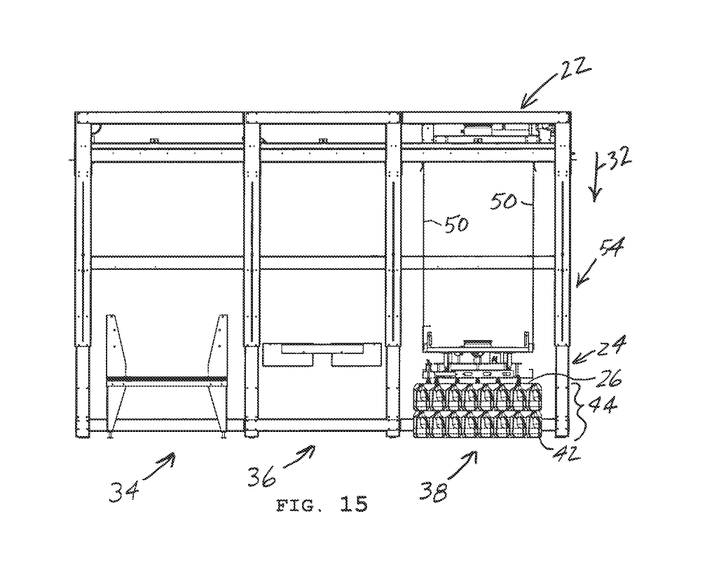

Once carriage 22 reaches station 38, flexible material 50 is deployed from carriage 22, lowering article array head 24 and component 26 in vertical direction 32. Article array head 24 and component 26 are further lowered in vertical direction 32 until reaching or are in close proximity to an extended vertical position 54, such that component 26 is positioned on top of and engages the most recently previously positioned article array 42 of partially palletized array 44, as shown in FIG. 15.

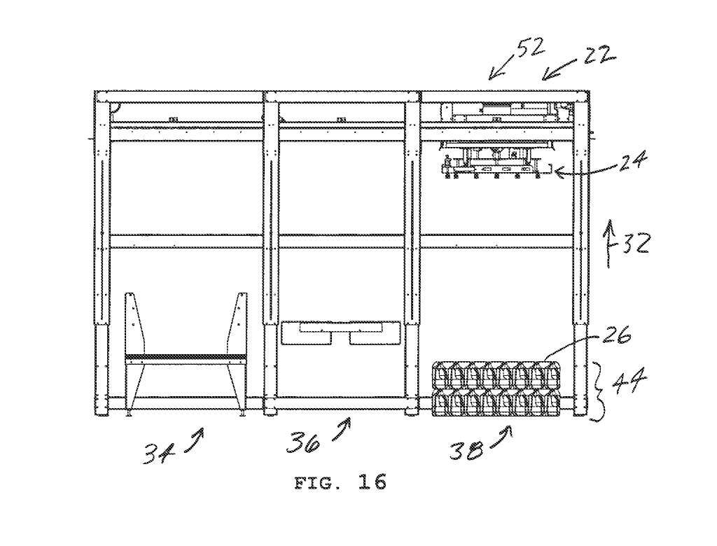

Once article array head 24 is disengaged from component 26, flexible members 50 are retracted such that article array head 24 moves in vertical direction 32 until reaching or is in close proximity to retracted vertical position 52 of station 38, as shown in FIG. 16.

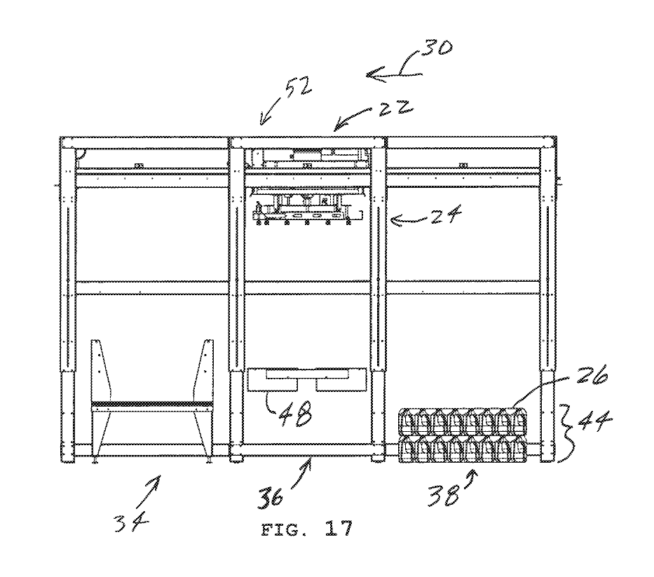

Once article array head 24 reaches or is in close proximity to retracted vertical position 52, carriage 22 is moved in horizontal direction 30 from station 38 to station 36, as shown in FIG. 17. The process then returns to FIG. 5 and is repeated until a fully formed palletized array has been constructed in station 38. Upon removal of the fully formed palletized array from station 38, the process then returns to FIG. 5 and is repeated.

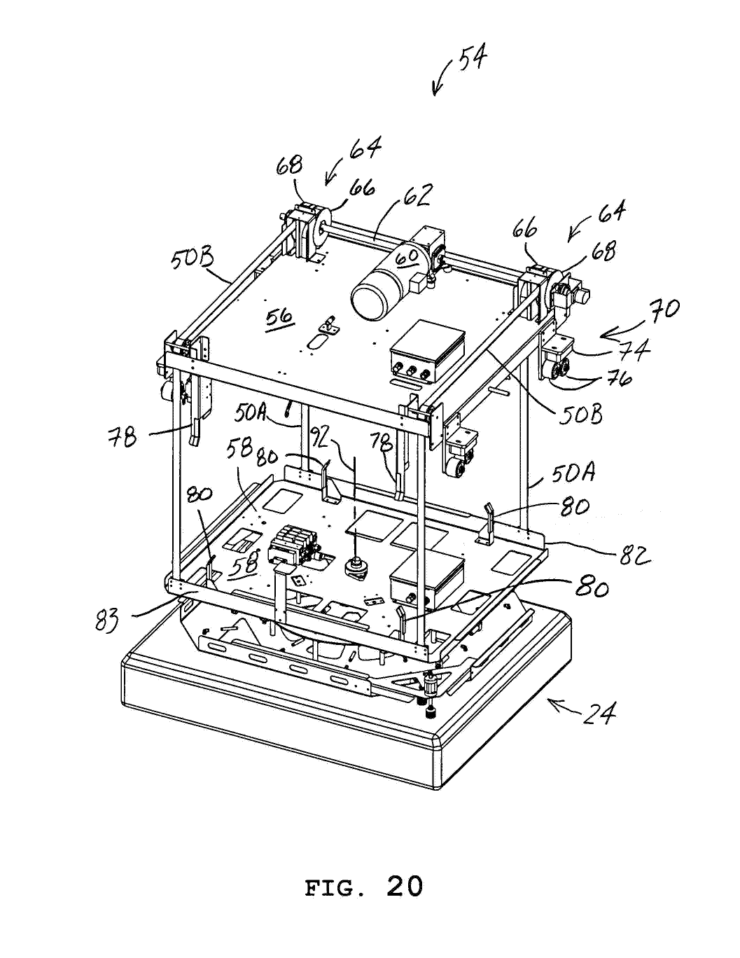

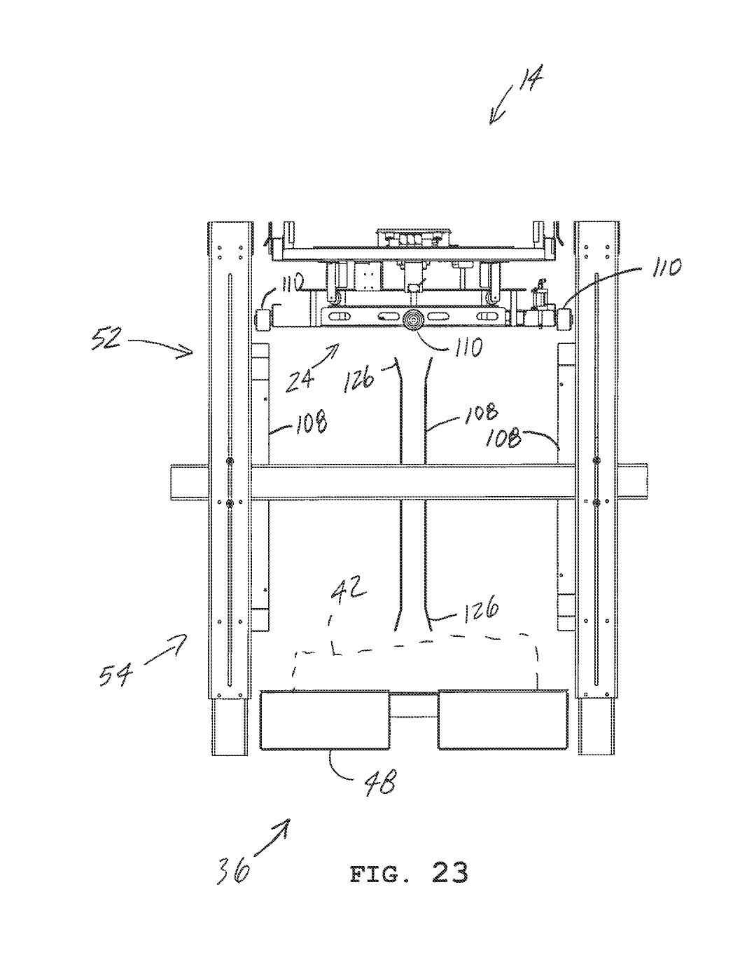

It is noted that in the system/process described above, movement of the article array head 24 is generally constrained to the interior of the frame 14, such as for purposes of safety. Moreover, carriage 22 is not permitted to or is unable to or is incapable of simultaneously moving article array head 24 in the horizontal direction and the vertical direction. That is, such movement of carriage 22 and article array head 24 is restricted to movement in one plane, such as a vertical plane, and more specifically, individual, incremental movement of each of the carriage 22 and article array head 24 is limited to a single direction, such as shown in FIGS. 5-17, with article array head 24 being incapable of simultaneous individual vertical movement relative to the frame 14, as carriage 22 is constrained to horizontal movement. In one embodiment, further guidance or positioning may be provided such as by guide members 78, 80 (FIG. 20) when the article array head 24 is at least positioned in or in close proximity to the retracted vertical position 52 (e.g., FIG. 13). Alternately, or in combination with guide members 78, 80, to provide controlled vertical movement between retracted vertical position 52 and extended vertical position 54, guide members 108 (FIG. 23) may be used, as will be further discussed in detail below. In other words, the guide members noted above may be configured to provide continuous support of the article array head over its entire range of movement in the vertical direction. As a result, inadvertent horizontal movement of article array head 24, such as “sway”, may be virtually eliminated, irrespective the vertical position of the article array head 24, despite article array head 24 being suspended by flexible members 50.

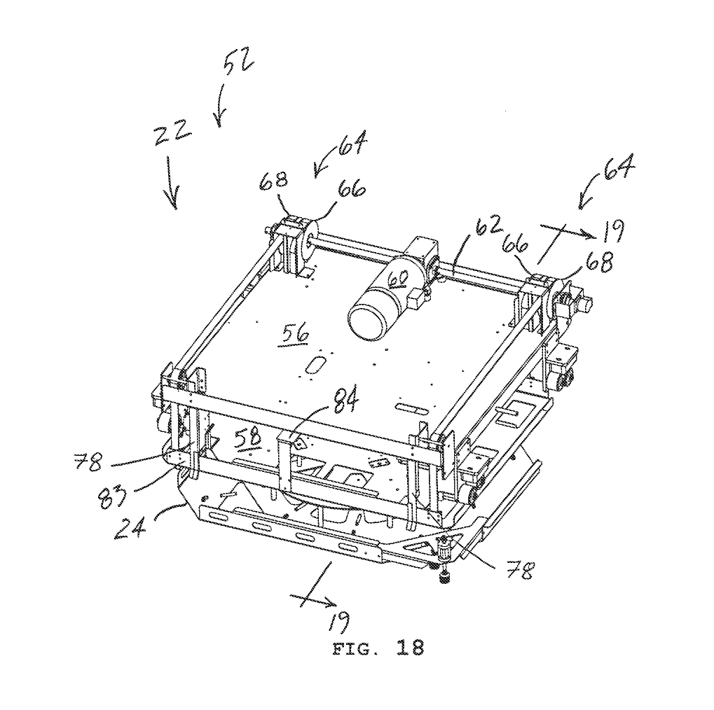

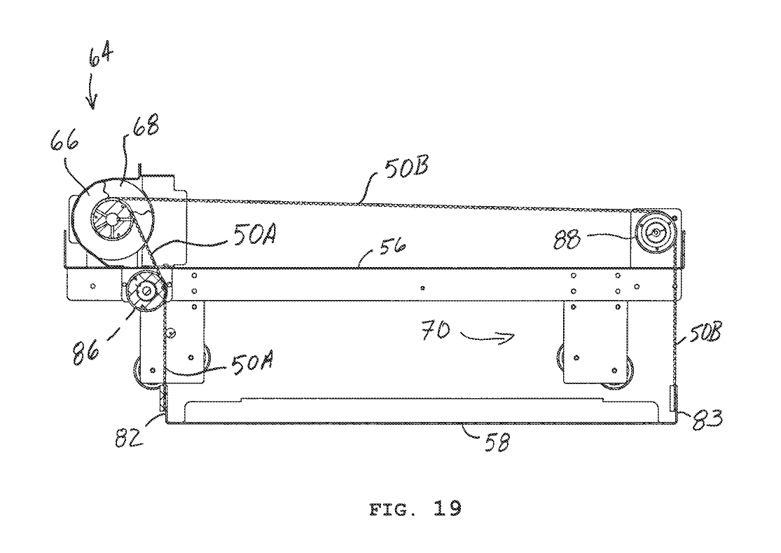

Carriage 22 will now be discussed. As shown in FIG. 18, carriage 22 includes a base 56 and a carriage portion 58 that is connected to article array head 24. As further shown in FIGS. 18, 19 and 20, carriage 22 includes a pair of pulley pairs 64 that are selectively rotatably driven about a common shaft 62 by a single motor 60. Pulley pair 64 includes first pulleys 66, 68 which deploy/retract respective flexible members 50A, 50B for vertically raising/lowering or suspendably supporting carriage portion 58 and article array head 24 relative to carriage 22. First pulley 66 deploys/retracts flexible member 50A that is engaged with and guided by a second pulley 86. Flexible member 50A then vertically extends from second pulley 86 to an opposite end that is connected to a flange 82 outwardly extending from carriage portion 58. First pulley 68 deploys/retract flexible member 50B that is engaged with and guided by a second pulley 88. Flexible member 50B then vertically extends from second pulley 88 to an opposite end that is connected to a flange 83 outwardly extending from carriage portion 56. Although a second pair of flexible members 50A, 50B deployed/retracted from a second pulley pair 64 are shown in FIGS. 18, 19 and 20, it may be possible to suspendably support carriage portion 58 and article array head 24 from a single pair of flexible members 50A, 50B that are suspended from a single pulley pair 64. In another embodiment, three or more pairs of flexible members 50A, 50B may be utilized to suspendably support carriage portion 58 and article array head 24 relative to carriage 22.

In one embodiment, the article array head may be directly suspended from the flexible members (i.e., not requiring the carriage portion.)

A control system (not shown) may utilize a number of techniques to control the vertical position, i.e., the amount of deployment/retraction of flexible members 50A, 50B such as by measuring rotation of common shaft 62 or counting features formed in or associated with one or more of the flexible members that are spaced at predetermined distances from each other. In other embodiments, the diameter of one or more of first pulleys 66, 68 may be measured, which diameter increasing or decreasing in a known relationship in response to deployment/retraction of the flexible members, or other suitable techniques.

As further shown in FIG. 18, a stop 84 is secured to flange 83 of carriage portion 58 for maintaining a minimal spacing between carriage portion 58 and base 56 when flexible members 50A, 50B are retracted by carriage 22 and the retracted vertical position 52 is achieved.

As shown in FIG. 20, a plurality of horizontal movement support devices 70 extending outwardly from base 56 are in a movably horizontally supported engagement with a pair of opposed guide rails 72 (FIG. 1). Each horizontal movement support device 70 includes a pad 74 having a low coefficient of friction and a pair of vertically offset rollers 76 for engaging corresponding walls of a corresponding guide rail 72 secured to the frame, such as frame 12 (FIG. 1). Coplanar guide rails 72 extend in a horizontal direction for supporting carriage 22 via support devices 70 in horizontal direction 30 (FIG. 1).

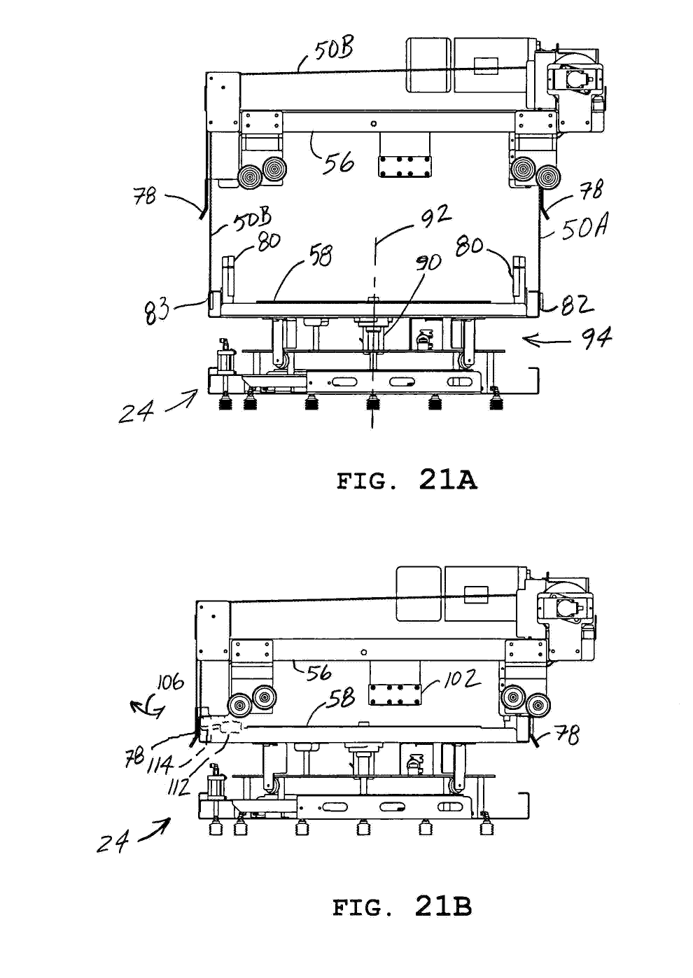

As shown in FIG. 20, a plurality, such as a pair of opposed pairs of guide members 80 extend upwardly and inwardly toward each other from carriage portion 58. Similarly, as shown in FIGS. 20, 21A, and 21B, a pair of opposed pairs of guide members 78 extend downwardly and outwardly from each other from base 56. As shown in the figures, guide member 78, 80 have a bent profile resembling a dogleg to facilitate alignment/engagement between base 56 and carriage portion 58 of carriage 22. In response to retraction of flexible members 50A, 50B by carriage 22 such that base 56 and carriage portion 58 are brought into close proximity to or in retracted vertical position 52, opposed pairs of guide members 78 are brought into contact with and apply a compressive retention force to corresponding portions of carriage portion 58 for positioning base 56 relative to carriage portion 58. Similarly, while not specifically shown, in response to base 56 and carriage portion 58 being brought into close proximity or in retracted vertical position 52, opposed pairs of guide members 80 are brought into contact with and apply a tensile retention force to corresponding portions of base 56.

It is to be understood that the guide members may be shaped and/or arranged differently from the disclosed exemplary embodiment, so long as the guide members secure base 56 and carriage portion 58 of carriage 22 relative to each other (and to the frame 14 by virtue of engagement with the frame 14 and horizontal movement support devices 70) at least when carriage 22 is in close proximity to or in the retracted vertical position 52 or in close proximity to or in the extended vertical position 54.

As shown in FIG. 21B, guide member 78 may be connected to an actuator 112 having a retractable ram 114 such that guide member 78 may be urged into rotational movement 106 toward another guide member secured to body 56 or directly to body 56 itself, and applying a compressive retention force thereto. In other embodiments, one or more guide members, such as guide members 78, 80 or other guide member(s) extending from any of body 56, carriage portion 58 and/or frame 14 may be one or more of being rotatably movable, non-rotatably movable, such as translational movement, or otherwise movable in their entirety or portion thereof for applying a retention force between one of body 56, carriage portion 58, and frame 14.

FIGS. 21A and 21B show an embodiment of a connection between carriage portion 58 and article array head 24. As further shown in FIG. 21A, a rotation device 90 having an axis 92 extends between carriage portion 58 and article array head 24 for urging article array head 24 to rotate about axis 92 relative to carriage portion 58 of carriage 22. To facilitate this rotational movement, a turntable 94 extends between carriage portion 58 and article array head 24. Other embodiments of the rotational device may include an actuator having a retractable ram extending between carriage portion 58 and article array head 24, a motor utilizing a belt drive, or other suitable construction, so long as the desired rotational movement of article array head 24 relative to carriage portion 58 of carriage 22 is achieved.

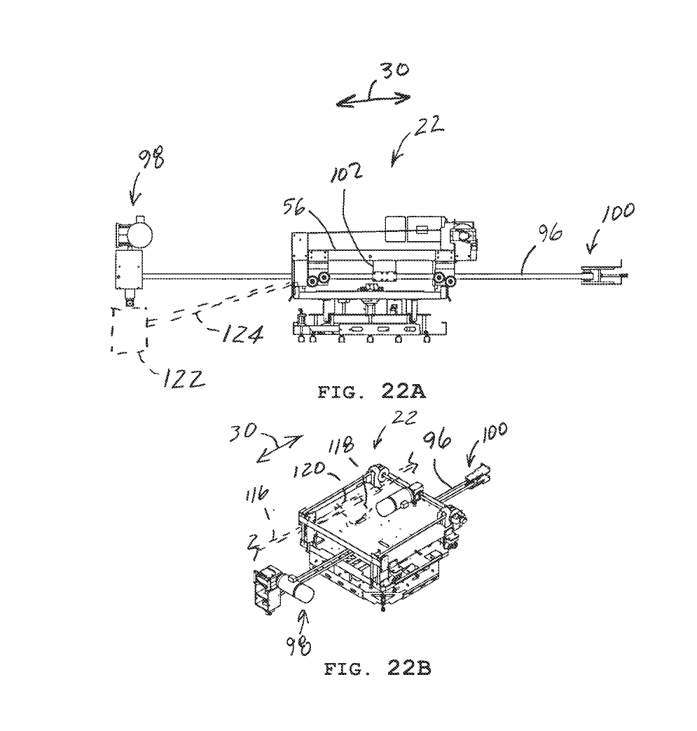

FIG. 22A shows an embodiment for moving carriage 22 in horizontal direction 30. As further shown in FIG. 22A, a protruding feature such as a tab 102 extending from base 56 of carriage 22 is configured to form a fixed connection with a loop 96 of a suitable flexible material that is rotatably driven by a motor 98 at one end of loop 96 and rotatably engaging a pulley 100 at the other end of loop 96. In an alternate embodiment, an actuator 122 having a retractable ram 124 of sufficient “throw” may be used for selectively moving carriage 22 in horizontal direction 30. In another alternate embodiment, as shown in FIG. 22B, carriage 22 may include a motor 118 having a movement device 120 drivably connected to motor 118, with movement device 120 engaging a strip 116 secured to the frame (not shown) for moving carriage 22 in a horizontal direction 30.

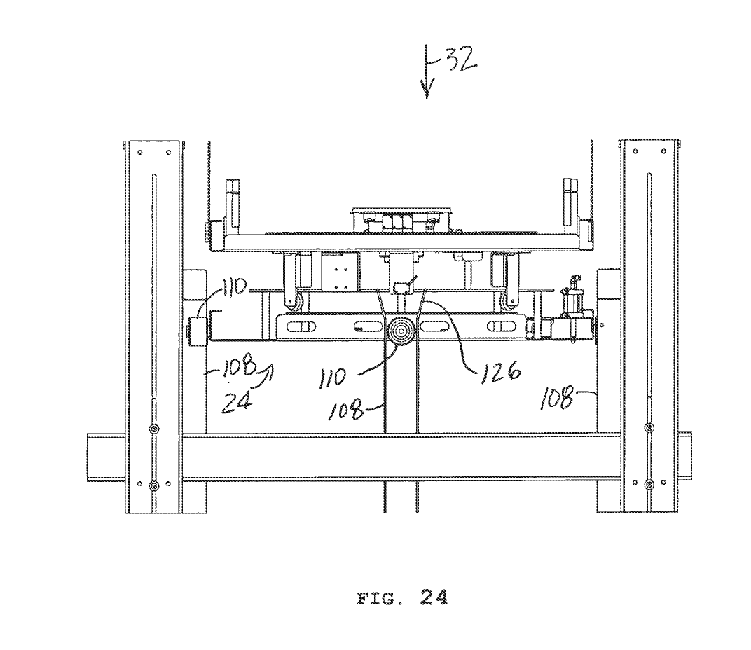

FIGS. 23 and 24 show a plurality of guide devices 108 secured to corresponding portions of the frame, such as in station 36 of frame 14 (FIG. 5) for engagement with a corresponding roller 110 extending outwardly from article array head 24, such that article array head 24 is guidably moved. For example, as shown in FIG. 23, conveyor 48 provides article arrays 42 to station 36 of frame 14. In order to engage the article array 42, article array head 24 is vertically lowered in a manner as previously discussed, except that prior to being vertically lowered, rollers 110 are aligned with outwardly tapered portions 126 of corresponding guide members 108, which alignment is facilitated by outwardly tapered portions 126. Once pins 110 are engaged with corresponding guide members 108, further lowering of article array head 24 results in article array head 24 being provided with a continuously guided passageway that prevents inadvertent or unintended movement in a horizontal direction or rotational movement about a vertical axis. If desired, the guide members 108 may extend sufficiently such that guide members 108 remain in engagement with pins 110 when article array head 24 achieves the extended vertical position 54. In one embodiment, the guide members 108 may extend sufficiently such that other guide members, such as guide members 78, 80 may still be engaged with one another or in engagement with at least one of the carriage portion 58 and the base 56 (FIG. 20) (i.e., in close proximity to the retracted vertical position 52) until rollers 110 are vertically lowered into engaged with outwardly tapered portions 126 of corresponding guide members 108, or until rollers 110 are fully engaged with (i.e., vertically lowered past outwardly tapered portions 126) corresponding guide members 108.

For purposes herein, “guide” and “position” and variations thereof when used as a verb may be used interchangeably.

It is to be understood that the number and positioning of corresponding rollers and guide members may be different from that shown in the figures. Further, the guide members may be all of the same length or have different lengths, providing a guided passageway for the article array head substantially spanning the retracted vertical position and extended vertical position, or any portion thereof, as desired.

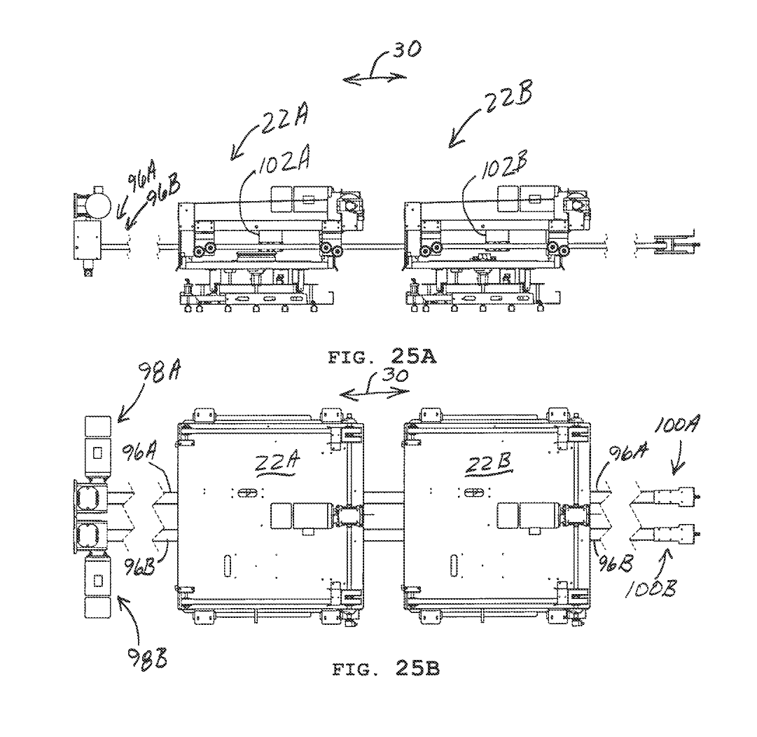

FIGS. 25A and 25B show a system having different carriages 22A, 22B, and an arrangement for providing horizontal movement for each carriage that is independent from one another. It is to be understood that while not specifically shown, flexible members for providing movement in a vertical direction for each of carriages 22A, 22B operate independently of one another. That is, horizontal and vertical movement of carriages 22A, 22B operate independently from each other. As further shown in FIG. 25B, carriage 22A is movable in horizontal directions 30 by virtue of a fixed connection between a tab 102A of carriage 22A and a loop 96A of a suitable flexible member. One end of loop 96A is drivably engaged by a motor 98A, with the other end of loop 96A engaging pulley 100A. Similarly, as further shown in the FIG. 25B, carriage 22B is movable in horizontal directions 30 by virtue of a fixed connection between a tab 102B of carriage 22B and a loop 96B of a suitable flexible member. One end of loop 96B is drivably engaged by a motor 98B, with the other end of loop 96B engaging pulley 100B. As shown in FIG. 25A, loops 96A, 96B are vertically aligned, although in other embodiments, the flexible material loops may not be vertically aligned or may have some other arrangement, so long as the loops do not create interference and permit horizontal movement of the carriages relative to one another. Such an arrangement permits an overlap of travel in horizontal direction 30 by carriages 22A, 22B. In another embodiment, more than two carriages may be used in the same system, if desired.

It is to be understood that the multiple carriages may have similar or different article array heads, as previously discussed.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for loading/unloading an article array head comprising:
a frame; and
a carriage selectively movably supported in a horizontal direction by the frame, the carriage selectively movably supporting an article array head in a vertical direction, movement of the article array head is constrained to interior of the frame;
wherein the article array head is suspended from the carriage by flexible members;
wherein the carriage is incapable of simultaneously moving the article array head in the horizontal direction and the vertical direction.

2. The system of claim 1, wherein the flexible members are selected from the group comprising straps, belts, cables and any combination thereof.

3. The system of claim 1, wherein the article array head is selected from the group comprising a palletizer, a gripping device, a slip sheet mover, a top cap mover, and a combination thereof.

4. The system of claim 1, wherein the carriage further comprising a base and a carriage portion, and further comprising a guide system comprising a guide device positioned at least partially interior of the frame to secure the carriage portion relative to the frame during movement in a vertical direction between a retracted vertical position and an extended vertical position.

5. The system of claim 4, wherein at least when the carriage portion is in close proximity to the retracted vertical position, the carriage portion is guided by guide members of the guide system, the guide members applying a retention force to at least one of the carriage portion and the base.

6. The system of claim 4, wherein at least when the carriage portion is in close proximity to the retracted vertical position, the carriage portion is guided by guide members of the guide system, the guide members applying a compressive retention force to at least one of the carriage portion and the base.

7. The system of claim 6, further comprising an actuator connected to one guide member for selectively moving the one guide member toward a corresponding guide member, the one guide member and the corresponding guide member applying a compressive retention force to at least one of the carriage portion and the base.

8. The system of claim 4, wherein at least when the carriage portion is in close proximity to the extended vertical position, the carriage portion is guided by guide members of the guide system, the guide members applying a retention force to at least one of the carriage portion and the base.

9. The system of claim 4, wherein at least when the carriage portion is in close proximity to the extended vertical position, the carriage portion is guided by guide members of the guide system, the guide members applying a compressive retention force to at least one of the carriage portion and the base.

10. The system of claim 9, further comprising an actuator connected to one guide member for selectively moving the one guide member toward a corresponding guide member, the one guide member and the corresponding guide member applying a compressive retention force to at least one of the carriage portion and the base.

11. The system of claim 1, wherein actuation of a single motor drivably retracts/deploys the flexible members.

12. The system of claim 1, wherein the carriage comprises:
at least one pulley pair selectively rotatably driven by a common shaft;
each first pulley of the at least one pulley pair retracts/deploys flexible material therefrom in engagement with a corresponding second pulley;
wherein the flexible material extending from each second pulley suspendably supports the article array head.

13. The system of claim 1, wherein the carriage comprises one of:
a motor connected to the carriage and rotatably driving a pulley in engagement with a strip connected to the frame, or
the carriage having a fixed connection with a loop of flexible material in engagement with the pulley rotatably driven by the motor, the motor connected to the frame,
wherein the motor rotatably driving the pulley results in a horizontal movement of the carriage relative to the frame.

14. The system of claim 1, further comprising an actuator having a retractable ram extending between the frame and the carriage for moving the carriage in a horizontal direction.

15. The system of claim 1, wherein carriage support in the horizontal direction is a linear direction.

16. The system of claim 1, wherein the carriage comprises a rotation device for selectively rotating the article array head about an axis.

17. A method for loading/unloading an article array head comprising:
providing a frame configured to receive an article array in a first station of the frame and a component to be positioned beneath or over the article array and a second station of the frame;
moving the component from the second station to the first station over the article array or moving the article array from the first station to the second station over the component, using a combination of vertical movement and horizontal movement, wherein the vertical movement and the horizontal movement do not occur simultaneously, and wherein movement of both the component and the article array is constrained to interior of the frame.

18. A system for loading/unloading multiple article array heads comprising:
a frame;
a first carriage selectively movably supported in a horizontal direction by the frame, the first carriage selectively movably supporting a first article array head in a vertical direction, movement of the first article array head is constrained to interior of the frame;
wherein the first article array head is suspended from the first carriage by first flexible members;
wherein the first carriage is incapable of simultaneously moving the first article array head in the horizontal direction and the vertical direction; and
a second carriage selectively movably supported in a horizontal direction by the frame, the second carriage selectively movably supporting a second article array head in a vertical direction, movement of the second article array head is constrained to interior of the frame;
wherein the second article array head is suspended from the second carriage by second flexible members;
wherein the second carriage is incapable of simultaneously moving the second article array head in the horizontal direction and the vertical direction.

19. The system of claim 18, wherein movement of the first article array head is independent of the second article array head.

20. The system of claim 18, wherein travel in the horizontal direction by the first carriage and the second carriage overlap each other.
